(19) United States
(12) Patent Application Publication
(10) Pub. No.: US 2020/0164416 A1
(43) Pub. Date: May 28, 2020

(54) Bucket-Scrapping Implement for Viscous Liquids

(71) Applicant: Vincent DiSisto, Beverton, OR (US)

(72) Inventor: Vincent DiSisto, Beverton, OR (US)

(21) Appl. No.: 16/201,999

(22) Filed: Nov. 27, 2018

(51) Int. Cl. B08B 9/08; B25G 1/10

(52) U.S. Cl. CPC B08B 9/0808; B25G 1/10

(57) ABSTRACT

A bucket-scrapping implement having a lower arcuate surface form-fit to engaging an interior surface of a cylindrical bucket, the bucket-scrapping implement comprising two upwardly- and outwardly-sweeping lateral wings adapted to aggregate and facilitate removal of viscous remnant materials from a cylindrical bucket.

### FIELD OF THE INVENTION

This invention relates to paint buckets and perishable foods, and more particularly relates to a scrapping apparatus for removing remnant paint, batter, and viscous liquids from the inside of cylindrical buckets and storage containers.

### BACKGROUND

### DESCRIPTION OF THE RELATED ART

Cylindrical buckets, including five-gallon storage buckets, for paint and food perishables are well-known in the art and proliferate worldwide. Such buckets are typically fabricated from metallic or polymeric materials, such aluminum or plastics.

Painters and contractors making use of five-gallon buckets, as well as larger and smaller buckets, face difficulty completely emptying the buckets of their contents. Paint, oils, and batter are often viscous. Vestiges or remnants of these stored viscous materials stick to the sides of the bucket and are not easily poured out and used to fulfill whatever application bucket contents were acquired for. Paint sticks to the inside of buckets where it dries and becomes inutile. Batter likewise dries and becomes inutile. Other viscous chemicals dry and become inert. In addition to wasting a percentage of the bucket contents at expense to users, these remnant contents may present hazardous waste disposal problem. The presence of these remnants also renders the bucket itself inutile for subsequently purposes and prevents the bucket from being stacked and stored with other buckets.

The inconvenience and difficulty encountered by individuals attempting to make optimal use of bucket contents could be substantially alleviated if a device which overcomes these shortcomings in the art were available, including a scrapping device which optimally scrapped and removed contents of cylindrical buckets. There is a substantial need for a means of curing these deficiencies in the art.

As such, it would be desirable to provide a bucket scrapping implement for viscous liquids that is relatively easy to fabricate, use and manipulate. It is therefore an object of the present invention to provide a bucket scrapping implement for aggregating and removing viscous liquids according to the needs of a user from a bucket or cylindrical storage container.

### SUMMARY

From the foregoing discussion, it should be apparent that a need exists for a bucket scrapping implement for viscous liquids. Beneficially, such a device would overcome inefficiencies with the prior art by providing an inexpensive, efficient means of removing bucket remnants.

The present invention has been developed in response to the present state of the art, and in particular, in response to the problems and needs in the art that have not yet been fully solved by currently available apparti. Accordingly, the present invention has been developed to provide a bucket-scrapping implement for viscous liquids, the bucket-scrapping implement comprising: an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement; wherein an upper concave surface of each lateral wing defines a recess for collecting viscous remnant material from a bucket; and a bulbous handle positioned directly above the lower member, the handle affixed to one or more of the lower member and a main body.

The bucket-scrapping implement may further comprise a main body affixed to the handle and the lower member.

The handle may define a keyhole-shaped aperture adapted to hang the bucket-scrapping implement on a hook.

The lower member may define a concave track running parallel to the peripheral edges separating the two lateral wings.

A second bucket-scrapping implement for viscous liquids is provided, the bucket-scrapping implement comprising: an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement; wherein an upper concave surface of each lateral wing defines a recess for collecting viscous remnant material from a bucket; and a protuberance adapted to function as a handle positioned above and behind the lower member, the protuberance affixed to one or more of the lower member and a main body; wherein the lower member defines a concave track running parallel to the peripheral edges separating the two lateral wings.

The bucket-scrapping implement may further comprise a main body affixed to the handle and the lower member.

In various embodiments, the handle defines a keyhole-shaped aperture adapted to hang the bucket-scrapping implement on a hook.

A third bucket-scrapping implement for viscous liquids is provided, the bucket-scrapping implement comprising: an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement; a cylindrical handle positioned directly above the lower member, the handle affixed to the lower member and a main body, the handle parallel across its longest axis to the peripheral edges.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper side forward perspective view of a set of bucket scrapping implements for viscous liquids in accordance with the present invention;

FIG. 2 is a forward perspective view of a bucket scrapping implement for viscous liquids in accordance with the present invention;

FIG. 3 is a side perspective view of a bucket scrapping implement for viscous liquids in accordance with the present invention;

FIG. 4 is a rearward side perspective view of a bucket scrapping implement for viscous liquids in accordance with the present invention; and

FIG. 5 is an upper side rearward perspective view of a set of bucket scrapping implements for viscous liquids in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

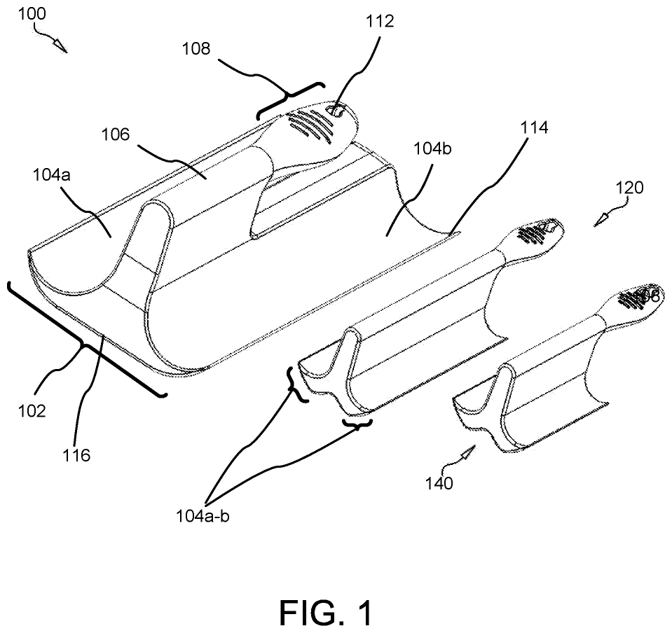

FIG. 1 is an upper side forward perspective view of a set of bucket scrapping implements 100, 120, 140 for viscous liquids in accordance with the present invention.

The larger 100 of the three implements 100, 120, 140 comprises a convex arcuate lower member 102 having two butterflied lateral wings 104a-b which sweep outwardly from the main body 106 of the implement 100 spanning the breadth of the implement 100. These lateral wings are arcuate in that a peripheral lateral edge 114 defined by both lateral wings 104a-b positions above the center point 116 of the bottom surface of the lower member 102. The lower surface of the lower member 102 sweeps outwardly and upwardly toward the peripheral edges 114.

The implement 100 comprises a bulbous handle 108 defining a keyhole-shaped aperture 112 for hanging the implement on a hook affixed to a belt, ladder, bucket or other apparatus.

The main body 106 of the implement 100 spans only a partial distance of the width of the implement 100 and interconnected the handle 108 and the lower member 102. In various embodiments, the lower member 102, handle 108, and main body 106 are formed as a single integrated piece.

The handle 108 is affixed to the main body 106 such that the handle 108 positions directly above the lower member 102. In alternative embodiments, such as implements 120, 140, the handle 108 may position above and behind the main body 106 of the implement 120, 140. The handle 108 is parallel in some embodiments, with the width of the lower surface of the lower member 102.

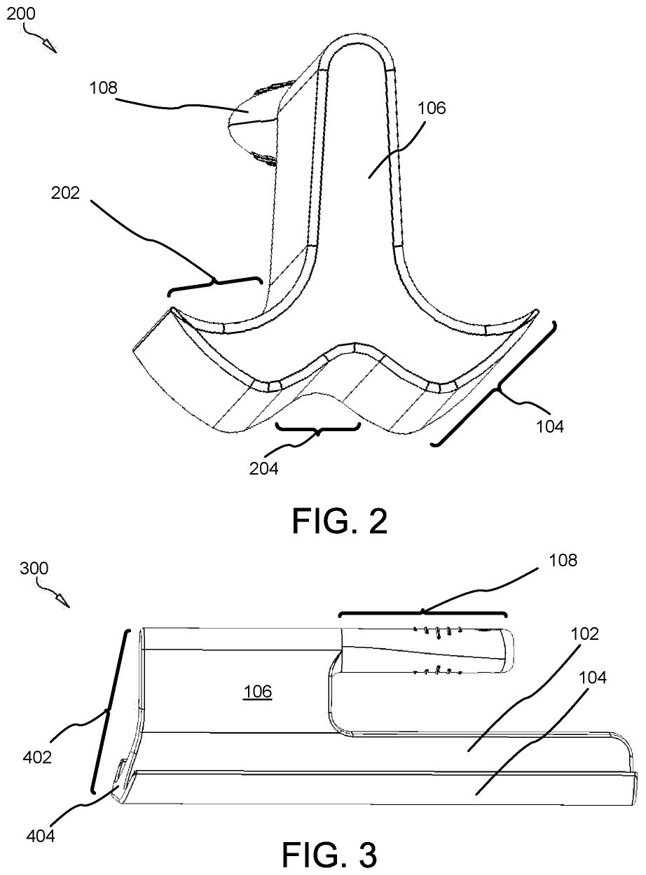

FIG. 2 is a forward perspective view of a bucket scrapping implement 200 for viscous liquids in accordance with the present invention.

It is an object of the present invention to provide the implements 100, 120, 140 adapted to be held inside a bucket by the handle 108 and used to scrap remnant paint or residual viscous material from inside a bucket, the aggregate the same, and facilitate removal of the same. The scrapped material is aggregated into recesses 202 above the lateral wings 104 where the scrapped material may be deposited into pans, trays or otherwise used or disposed of. The lower surface of the lower member 102 is adapted to contour and provide optimal scrapping function to the inside surface of a bucket.

The lower surface of the lower member 102 may define a track running parallel to the peripheral edges 114 which is recessed in concave form into the lower surface of the lower member 102. This recess allows pressure to be non-uniformly applied across the lower surface of the lower member 102 and allows the lateral wings 104 to alternatively be pressed alone into the interior surfaces of a bucket without obstruction for the center point 116 in scrapping function.

FIG. 3 is a side perspective view of a bucket scrapping implement 300 for viscous liquids in accordance with the present invention.

As shown the forward surface 402 of the implement 300 is not perpendicular to the handle 108 nor is the forward surface 402 planar. Rather, the forward edge 404 of the lower member 102 juts forward of the main body 106, facilitating forward engagement of the lower member 102 with a bucket bottom surface without interference or obstruction by the handle 108 and/or the main body 106.

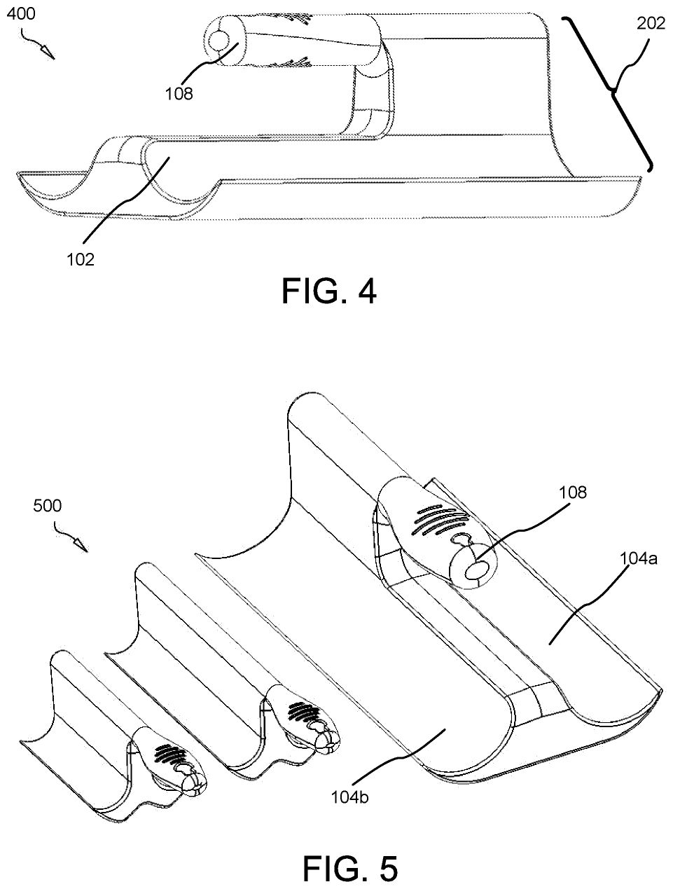

FIG. 4 is a rearward side perspective view of a bucket scrapping implement for viscous liquids 400 in accordance with the present invention.

The handle 108, in some embodiments of the implement 400, positions substantially over a center area of the lower member 102 and is affixed to the main body 106. The recess 202 for collecting remnant viscous material is defined by the upper surface of the lateral wings 104 and the main body 106.

FIG. 5 is an upper side rearward perspective view of a set of bucket scrapping implements for viscous liquids 500 in accordance with the present invention.

In various embodiments, there is not main body 106. Rather, the handle 108 is affixed directly to the lower member 104 and/or the lateral wings 104. The handle 108 may be bulbous, cylindrical, or irregularly-shaped. The handle 108 may be heat-pressed onto an existing surface or affixed using means known to those of skill in the art to the lower member 102. The handle 108 may simply comprise a protuberance from the main body 106 and/or the lower member 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bucket-scrapping implement for viscous liquids, the bucket-scrapping implement comprising:
an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement;
wherein an upper concave surface of each lateral wing defines a recess for collecting viscous remnant material from a bucket; and
a bulbous handle positioned directly above the lower member, the handle affixed to one or more of the lower member and a main body.

2. The bucket-scrapping implement of claim 1, further comprising a main body affixed to the handle and the lower member.

3. The bucket-scrapping implement of claim 1, wherein the handle defines a keyhole-shaped aperture adapted to hang the bucket-scrapping implement on a hook.

4. The bucket-scrapping implement of claim 1, wherein the lower member defines a concave track running parallel to the peripheral edges separating the two lateral wings.

5. A bucket-scrapping implement for viscous liquids, the bucket-scrapping implement comprising:
an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement;
wherein an upper concave surface of each lateral wing defines a recess for collecting viscous remnant material from a bucket; and
a protuberance adapted to function as a handle positioned above and behind the lower member, the protuberance affixed to one or more of the lower member and a main body;
wherein the lower member defines a concave track running parallel to the peripheral edges separating the two lateral wings.

6. The bucket-scrapping implement of claim 1, further comprising a main body affixed to the handle and the lower member.

7. The bucket-scrapping implement of claim 1, wherein the handle defines a keyhole-shaped aperture adapted to hang the bucket-scrapping implement on a hook.

8. A bucket-scrapping implement for viscous liquids, the bucket-scrapping implement comprising:
an arcuate lower member comprising two upwardly- and outwardly-sweeping lateral wings, the lateral wings each defining a peripheral edge positioned above a center point of the lower member on a bottom surface of the lower member, the lateral wings spanning a width of the bucket-scrapping implement;
a cylindrical handle positioned directly above the lower member, the handle affixed to the lower member and a main body, the handle parallel across its longest axis to the peripheral edges.
